(19) United States
(12) Patent Application Publication
(10) Pub. No.: US 2026/0328633 A1
(43) Pub. Date: Oct. 22, 2026

(54) PRESSURE SENSOR STRUCTURE AND FABRICATION METHOD THEREOF

(71) Applicant: Vanguard International Semiconductor Corporation, Hsinchu (TW)

(72) Inventors: Chien-Hui Li, Hsinchu County (TW); Yung-Hsiang Chen, Hsinchu City (TW); Chien-Hsun Wu, Hsinchu City (TW); Cheng-Ping Chang, Hualien County (TW)

(73) Assignee: Vanguard International Semiconductor Corporation, Hsinchu (TW)

(21) Appl. No.: 19/182,550

(22) Filed: Apr. 17, 2025

(51) Int. Cl. G01L 9/00; G01L 19/00

(52) U.S. Cl. CPC G01L 9/0045; G01L 9/0048; G01L 19/0076

(57) ABSTRACT

A pressure sensor structure includes a semiconductor substrate, a composite diaphragm, a cavity, a semiconductor resistor, and a cap plate. The semiconductor substrate has a first surface and a second surface on opposite sides. The composite diaphragm is embedded in the semiconductor substrate and located near the first surface. The cavity is disposed in the semiconductor substrate and extends from the second surface to the composite diaphragm. The semiconductor resistor is disposed on the composite diaphragm and located directly above the cavity. The cap plate is bonded to the semiconductor substrate to seal the cavity.

### BACKGROUND OF THE INVENTION

### 1. FIELD OF THE INVENTION

The present disclosure relates generally to semiconductor manufacturing technology, and more particularly to pressure sensor structures and fabrication methods thereof.

### 2. DESCRIPTION OF THE PRIOR ART

Pressure sensors convert sensed pressure into electrical signal output via a reading circuit, thereby enabling analysis of the output electrical signal to obtain the change in measured pressure. Currently, pressure sensors are widely used in various electronic consumer products. The main sensing types of pressure sensors are piezoelectric, piezoresistive, capacitive, and inductive sensors. Capacitive pressure sensors exhibit good temperature stability and low noise, but are susceptible to parasitic capacitance. Micro-Electro-Mechanical Systems (MEMS) sensors are microscopic devices that integrate mechanical and electrical components to sense physical quantities and/or to interact with their surrounding environment. Compared with traditional sensors, MEMS pressure sensors offer advantages such as low power consumption, small size, high sensitivity, and low cost. For example, a piezoresistive MEMS pressure sensor uses the pressure difference between an airtight cavity and the external environment to cause a diaphragm to bend or deform, thereby changing the resistance of a resistor element within the diaphragm. Accordingly, the pressure is converted into a corresponding electrical signal for measuring the external environment’s pressure change. However, current pressure sensors still cannot fully meet all requirements.

### SUMMARY OF THE INVENTION

In view of this, the present disclosure provides pressure sensor structures and fabrication methods thereof. In the pressure sensor structures, a composite diaphragm is embedded in a semiconductor substrate. The composite diaphragm is used for pressure sensing and serves as an etch stop layer for cavity formation. Therefore, the pressure sensor structures do not require a semiconductor-on-insulator (SOI) substrate, thereby reducing manufacturing costs. Furthermore, embodiments of the present disclosure enable accurate control of the composite diaphragm’s thickness, as well as the cavity’s depth and size, thereby improving the sensitivity of the pressure sensor structures.

According to an embodiment of the present disclosure, a pressure sensor structure is provided and includes a semiconductor substrate, a composite diaphragm, a cavity, a semiconductor resistor, and a cap plate. The semiconductor substrate has a first surface and a second surface on opposite sides. The composite diaphragm is embedded in the semiconductor substrate and located near the first surface. The cavity is disposed in the semiconductor substrate and extends from the second surface to the composite diaphragm. The semiconductor resistor is disposed on the composite diaphragm and located directly above the cavity. The cap plate is bonded to the semiconductor substrate to seal the cavity.

According to an embodiment of the present disclosure, a method of fabricating a pressure sensor structure is provided and includes the following steps. A semiconductor substrate is provided, having a first surface and a second surface on opposite sides. A trench is formed by etching from the first surface of the semiconductor substrate. A composite diaphragm is formed in the trench. A semiconductor resistor is formed on the composite diaphragm. A cavity is formed by etching from the second surface of the semiconductor substrate. The etching to form the cavity stops at the composite diaphragm, and the semiconductor resistor is located directly above the cavity. In addition, a cap plate is provided and bonded to the semiconductor substrate to seal the cavity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

Aspects of the present disclosure are best understood from the following detailed description when read with the accompanying figures. It is noted that, in accordance with the standard practice in the industry, various features may not be drawn to scale. In fact, the dimensions of the various features may be arbitrarily increased or reduced for clarity of discussion.

FIG. 1 is a schematic cross-sectional view of a pressure sensor structure according to an embodiment of the present disclosure.

FIG. 2 is a schematic top view of a pressure sensor structure according to an embodiment of the present disclosure.

FIG. 3 is a schematic top view of a pressure sensor structure according to another embodiment of the present disclosure.

FIG. 4 is a schematic cross-sectional view of a pressure sensor structure according to another embodiment of the present disclosure.

FIGS. 5 and 6 are cross-sectional views of some stages of a method for fabricating a pressure sensor structure according to an embodiment of the present disclosure.

FIGS. 7, 8, 9, and 10 are cross-sectional views of some stages of a method for fabricating a pressure sensor structure according to another embodiment of the present disclosure.

### DETAILED DESCRIPTION

The following disclosure provides many different embodiments, or examples, for implementing different features of the disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath”, “below”, “lower”, “under”, “on”, “over”, “above”, “upper”, “bottom”, “top” and the like, may be used herein for ease of description to describe one element or feature's relationship to another element(s) or feature(s) as illustrated in the figures. The spatially relative terms are intended to encompass different orientations of the pressure sensor structures in use or operation in addition to the orientation depicted in the figures. For example, if the pressure sensor structure in the figures is turned over, elements described as "below" and/or "under" other elements or features would then be oriented "above" and/or "over" the other elements or features. The apparatus may be otherwise oriented (rotated 90 degrees or at other orientations) and the spatially relative descriptors used herein may likewise be interpreted accordingly.

It is understood that, although the terms first, second, third, etc. may be used herein to describe various elements, components, regions, layers and/or sections, these elements, components, regions, layers and/or sections should not be limited by these terms. These terms may be only used to distinguish one element, component, region, layer and/or section from another region, layer and/or section. Terms such as "first", "second", and other numerical terms when used herein do not imply a sequence or order unless clearly indicated by the context. Thus, a first element, component, region, layer and/or section discussed below could be termed a second element, component, region, layer and/or section without departing from the teachings of the embodiments.

As disclosed herein, the term “about” or “substantial” generally means within 20%, 10%, 5%, 3%, 2%, 1%, or 0.5% of a given value or range. Unless otherwise expressly specified, all of the numerical ranges, amounts, values and percentages disclosed herein should be understood as modified in all instances by the term “about” or “substantial”. Accordingly, unless indicated to the contrary, the numerical parameters set forth in the present disclosure and attached claims are approximations that may vary as desired.

Furthermore, as disclosed herein, the terms "coupled to" and "electrically connected to" include any directly and indirectly electrical connecting means. Therefore, if it is described in this document that a first component is coupled or electrically connected to a second component, it means that the first component may be directly connected to the second component, or may be indirectly connected to the second component through other components or other connecting means.

Although the disclosure is described with respect to specific embodiments, the principles of the disclosure, as defined by the claims appended herein, can obviously be applied beyond the specifically described embodiments of the disclosure described herein. Moreover, in the description of the present disclosure, certain details have been left out in order to not obscure the inventive aspects of the disclosure. The details left out are within the knowledge of a person having ordinary skill in the art.

The present disclosure relates to pressure sensor structures including a composite diaphragm and fabrication methods thereof. The composite diaphragm is embedded in a semiconductor substrate, and a semiconductor resistor is disposed on the composite diaphragm. The composite diaphragm is used for pressure sensing and serves as an etch stop layer for cavity formation. Therefore, the pressure sensor structures do not require a silicon-on-insulator (SOI) substrate or other semiconductor-on-insulator substrates, thus saving manufacturing costs. Furthermore, embodiments of the present disclosure accurately control the composite diaphragm’s thickness, as well as the cavity’s depth and size, thereby improving the sensitivity of the pressure sensor structures. Moreover, the pressure sensor structures may utilize a p-type semiconductor substrate to facilitate integration with a complementary metal-oxide-semiconductor (CMOS) transistor.

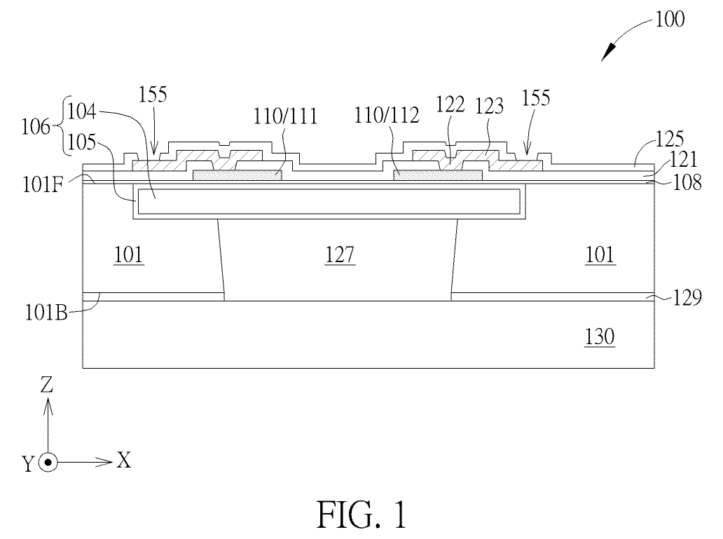

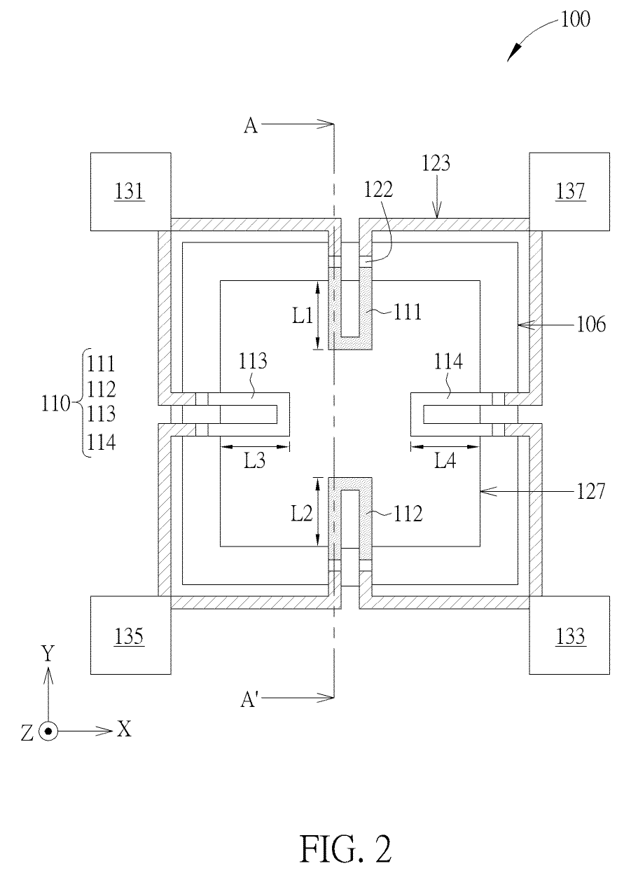

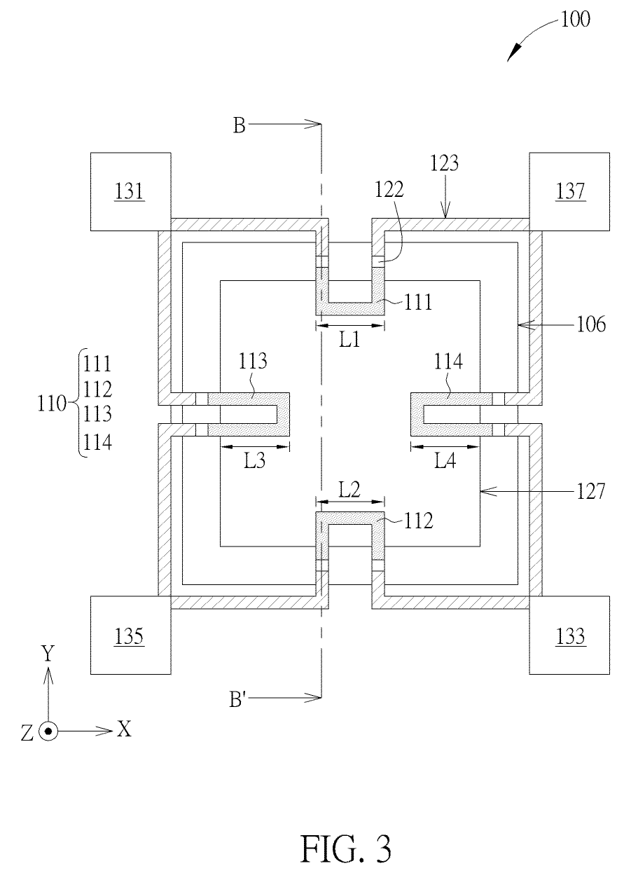

FIG. 1 is a schematic cross-sectional view of a pressure sensor structure 100 according to some embodiments of the present disclosure. FIGS. 2 and 3 are schematic top views of the pressure sensor structure 100 according to some embodiments of the present disclosure. FIG. 1 shows the cross-sectional view of the pressure sensor structure 100 taken along the line A-A’ in FIG. 2 and the line B-B’ in FIG. 3. As shown in FIG. 1, the pressure sensor structure 100 includes a semiconductor substrate 101, a composite diaphragm 106, a cavity 127, a semiconductor resistor 110, and a cap plate 130. The semiconductor substrate 101 has a first surface 101F and a second surface 101B on opposite sides. In some embodiments, the semiconductor substrate 101 may be an undoped, p-type, or n-type silicon substrate. The composite diaphragm 106 is embedded in the semiconductor substrate 101 and located near the first surface 101F. The composite diaphragm 106 includes an insulating layer 105 wrapping around a semiconductor filling layer 104. The top surface of the composite diaphragm 106 and the first surface 101F of the semiconductor substrate 101 are on the same plane. In some embodiments, the composition of the semiconductor filling layer 104 is, for example, undoped or lightly doped polysilicon. The composition of the insulating layer 105 is, for example, silicon oxide. The thickness of the semiconductor filling layer 104 is, for example, about 2 µm to about 3µm. The thickness of the insulating layer 105 is, for example, about 2000 Å to about 3000 Å. However, the compositions and the thicknesses of the composite diaphragm 106 are not limited to the aforementioned descriptions. In one embodiment, the insulating layer 105 may at least partially wrap the semiconductor filling layer 104. In a preferred embodiment, the insulating layer 105 completely wraps around the semiconductor filling layer 104, thereby providing good electrical isolation.

The cavity 127 is disposed in the semiconductor substrate 101 and extends from the second surface 101B to the composite diaphragm 106. The semiconductor resistor 110 is disposed on the composite diaphragm 106 and located directly above the cavity 127. A dielectric layer 108 such as a silicon oxide layer may optionally be disposed on the composite diaphragm 106 and the semiconductor substrate 101. The dielectric layer 108 is located between the semiconductor resistor 110 and the composite diaphragm 106. The cap plate 130 (e.g., a glass or silicon substrate) is bonded to the semiconductor substrate 101 through a bonding layer 129 (e.g., a silicon oxide layer), thereby sealing the cavity 127. Furthermore, a dielectric layer 121 is disposed on the semiconductor substrate 101, covering the semiconductor resistor 110. Multiple holes for conductive vias 122 are formed in the dielectric layer 121 to expose the semiconductor resistor 110. The composition of the dielectric layer 121 is, for example, silicon oxide or silicon nitride. A wire layer 123 is disposed on the dielectric layer 121 and fills up the holes of the conductive vias 122 in the dielectric layer 121. The wire layer 123 is electrically connected to the semiconductor resistor 110 through the conductive vias 122. A passivation layer 125 covers the wire layer 123 and the dielectric layer 121, with openings 155 to expose the wire layer 123. The wire layer 123 is electrically connected to an external circuit through the openings 155 by wire bonding or other means. After sealing the cavity 127, the cavity 127 is evacuated. The pressure difference between the cavity 127 and the external environment surrounding the pressure sensor structure 100 causes the composite diaphragm 106 to bend or deform, thereby changing the resistance of the semiconductor resistor 110 on the composite diaphragm 106. Accordingly, the pressure is converted into a corresponding electrical signal to measure the external environment’s pressure change.

In some embodiments, as shown in FIGS. 2 and 3, in the vertical projection direction (e.g., the XY plane), the boundary of the cavity 127 is within the boundary of the composite diaphragm 106. The semiconductor resistor 110 may be a Wheatstone bridge circuit including a first resistor 111, a second resistor 112, a third resistor 113, and a fourth resistor 114. The first resistor 111 and the third resistor 113 are electrically connected to a conductive pad 131 through the conductive vias 122 and the wire layer 123. The second resistor 112 and the fourth resistor 114 are electrically connected to a conductive pad 133 through the conductive vias 122 and the wire layer 123. The second resistor 112 and the third resistor 113 are electrically connected to a conductive pad 135 through the conductive vias 122 and the wire layer 123. The first resistor 111 and the fourth resistor 114 are electrically connected to a conductive pad 137 through the conductive vias 122 and the wire layer 123. A working voltage is input to the conductive pad 137, the conductive pad 135 is grounded, and an output voltage difference is measured between the conductive pad 131 and the conductive pad 133. When the composite diaphragm 106 is bent or deformed by pressure, the first resistor 111, the second resistor 112, the third resistor 113, and the fourth resistor 114 will be stressed, thereby changing their resistances. Therefore, the voltage difference measured between the conductive pad 131 and the conductive pad 133 corresponds to the pressure change for pressure sensing.

The composition of the semiconductor resistor 110 is, for example, doped polysilicon. In one embodiment, as shown in FIG. 2, the first resistor 111 and the second resistor 112 both have a first conductivity type, for example, both are made of n-type heavily doped polysilicon. The third resistor 113 and the fourth resistor 114 both have a second conductivity type, for example, both are made of p-type heavily doped polysilicon. The first resistor 111 and the second resistor 112 are separately arranged along a first direction (e.g., the Y-axis direction). The long axis L1 of the first resistor 111 and the long axis L2 of the second resistor 112 are both in the first direction (e.g., the Y-axis direction). The third resistor 113 and the fourth resistor 114 are separately arranged along a second direction (e.g., the X-axis direction). The long axis L3 of the third resistor 113 and the long axis L4 of the fourth resistor 114 are both in the second direction (e.g., the X-axis direction).

In this embodiment, when the composite diaphragm 106 is bent or deformed by pressure, the resistances of the long-axis portions of the third resistor 113 and the fourth resistor 114 along the second direction (e.g., the X-axis direction) will change due to the stress along the second direction. The change in the resistances of their short-axis portions along the first direction (e.g., the Y-axis direction) due to this stress along the second direction is negligible. Similarly, the resistances of the long-axis portions of the first resistor 111 and the second resistor 112 along the first direction (e.g., the Y-axis direction) will change due to the stress along the first direction. The change in the resistances of their short-axis portions along the second direction (e.g., the X-axis direction) due to this stress along the first direction is negligible. Moreover, the resistance changes caused by stress on a p-type resistor and an n-type resistor are opposite. Accordingly, the resistance changes of the first resistor 111 and the second resistor 112, both heavily doped n-type, correspond to the bending or deformation of the composite diaphragm 106 in the first direction. The resistance changes of the third resistor 113 and the fourth resistor 114, both heavily doped p-type, correspond to the bending or deformation of the composite diaphragm 106 in the second direction. Therefore, the semiconductor resistor 110 in FIG. 2 senses the bending or deformation of the composite diaphragm 106 in different directions caused by pressure.

In some other embodiments, as shown in FIG. 3, the first resistor 111, the second resistor 112, the third resistor 113, and the fourth resistor 114 all have the same conductivity type, for example, all are made of p-type heavily doped polysilicon, or all are made of n-type heavily doped polysilicon. The first resistor 111 and the second resistor 112 are separately arranged along a first direction (e.g., the Y-axis direction). The third resistor 113 and the fourth resistor 114 are separately arranged along a second direction (e.g., the X-axis direction). The long axis L1 of the first resistor 111, the long axis L2 of the second resistor 112, the long axis L3 of the third resistor 113, and the long axis L4 of the fourth resistor 114 are all in the second direction (e.g., the X-axis direction). When the composite diaphragm 106 is bent or deformed by pressure, the third resistor 113 and the fourth resistor 114 with their long axes in the second direction (e.g., the X-axis direction) will be subjected to stress along the second direction, thereby changing their resistances. Meanwhile, the first resistor 111 and the second resistor 112 with their long axes in the second direction (e.g., the X-axis direction) will be subjected to stress along the first direction (e.g., the Y-axis direction), and thus changes in their resistances are negligible. Therefore, the semiconductor resistor 110 in FIG. 3 senses the bending or deformation of the composite diaphragm 106 in different directions caused by pressure.

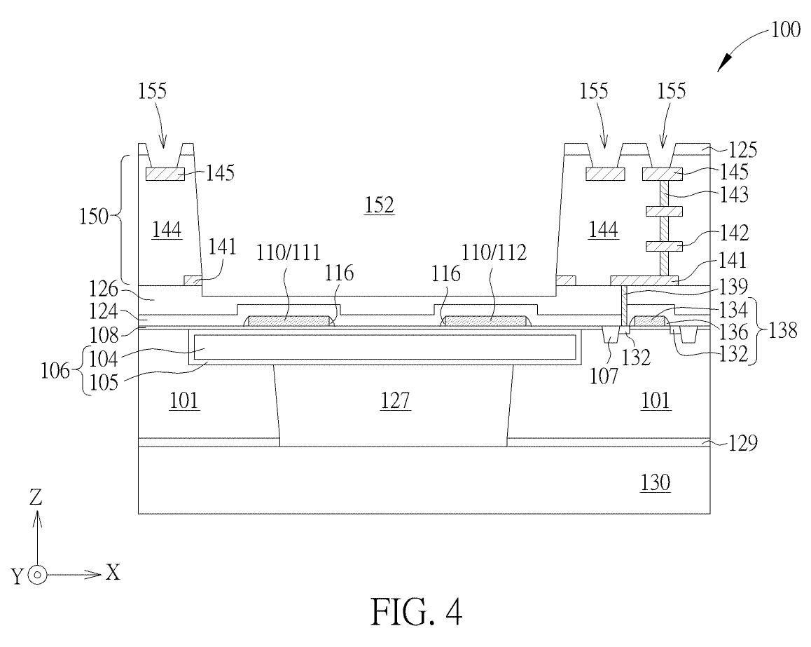

FIG. 4 is a schematic cross-sectional view of a pressure sensor structure 100 according to another embodiment of the present disclosure. In the pressure sensor structure 100 of FIG. 4, the layout of the resistors of the semiconductor resistor 110, the composite diaphragm 106, and the cavity 127 may refer to the top views of FIGS. 2 and 3. In this embodiment, the semiconductor substrate 101 may be a p-type silicon substrate, and the pressure sensor structure 100 further includes a transistor 138 disposed in the semiconductor substrate 101. In one embodiment, the transistor 138 is, for example, a complementary metal-oxide-semiconductor (CMOS) transistor. In the pressure sensor structure 100 of FIG. 4, an n-type channel MOS transistor in the CMOS transistor is illustrated as an example, where n-type heavily doped source/drain regions 132 are formed in a p-type semiconductor substrate 101. A portion of the dielectric layer 108 serves as a gate dielectric layer. A gate structure includes a gate electrode 134 and spacers 136 disposed on the sidewalls of the gate electrode 134. In addition, shallow trench isolation (STI) regions 107 are disposed in the semiconductor substrate 101 to isolate the transistor 138 from the composite diaphragm 106. In this embodiment, the composition of the semiconductor resistor 110 may be the same as that of the gate structure of the transistor 138. The composition of each resistor of the semiconductor resistor 110 and the composition of the gate electrode 134 may be doped polysilicon. Spacers 116 may be disposed on the sidewalls of each resistor. The composition of the spacers 116 is the same as that of the spacers 136, for example, silicon oxide, silicon oxynitride, or a combination of thereof.

The pressure sensor structure 100 of FIG. 4 further includes an interconnection layer 150 disposed above the semiconductor substrate 101. The interconnection layer 150 may be electrically connected to the transistor 138 and the semiconductor resistor 110. The interconnection layer 150 includes a first metal layer 141, a top metal layer 145, multiple intermediate metal layers 142, multiple conductive vias 143, and multiple inter-metal dielectric (IMD) layers 144. In addition, a dielectric layer 124 and an interlayer dielectric (ILD) layer 126 cover the semiconductor resistor 110. The first metal layer 141 may be electrically connected to a source/drain and a gate of the transistor 138 through conductive vias 139 that penetrate the dielectric layer 124 and the ILD layer 126. Furthermore, the first metal layer 141 and the conductive vias 139 are also electrically connected to the semiconductor resistor 110.

In addition, a pressure sensor window 152 penetrates the interconnection layer 150 and is located directly above the semiconductor resistor 110. The composite diaphragm 106 and the semiconductor resistor 110 sense the pressure of the external environment through the pressure sensor window 152. A passivation layer 125 is disposed on the interconnection layer 150. A plurality of openings 155 are formed in the passivation layer 125 and the interconnection layer 150 to expose the top metal layer 145. The top metal layer 145 may be electrically connected to an external circuit through the openings 155 by wire bonding or other means. Moreover, the conductive pad 131, the conductive pad 133, the conductive pad 135, and the conductive pad 137 in FIGS. 2 and 3 may be replaced by the first metal layer 141 and the conductive via 139 in FIG. 4, and these conductive pads may be electrically connected to CMOS transistors. The details of other features of the pressure sensor structure 100 in FIG. 4 may refer to the aforementioned description of the pressure sensor structure 100 in FIG. 1, which will not be repeated here.

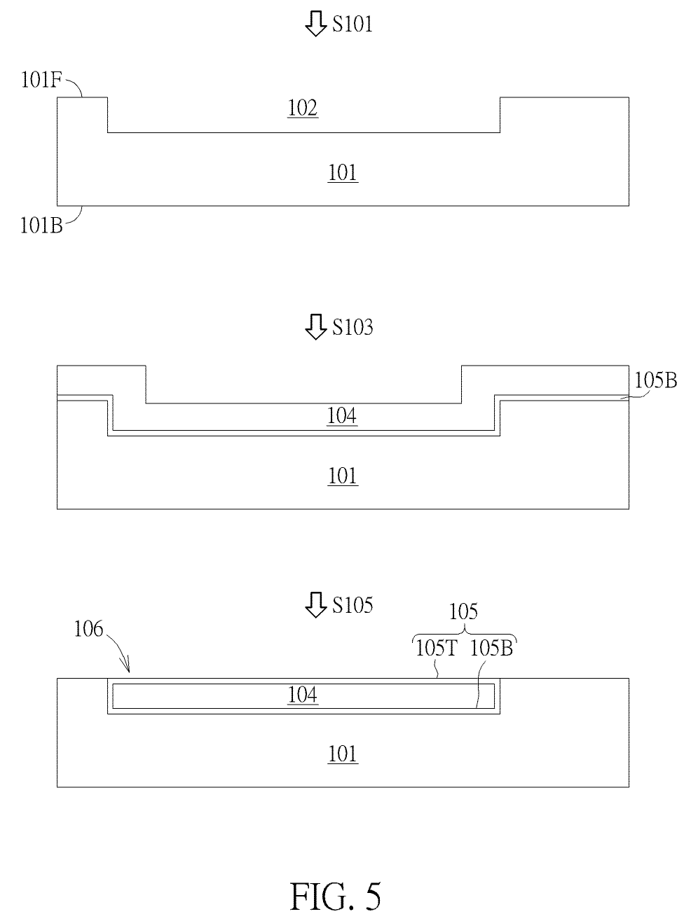

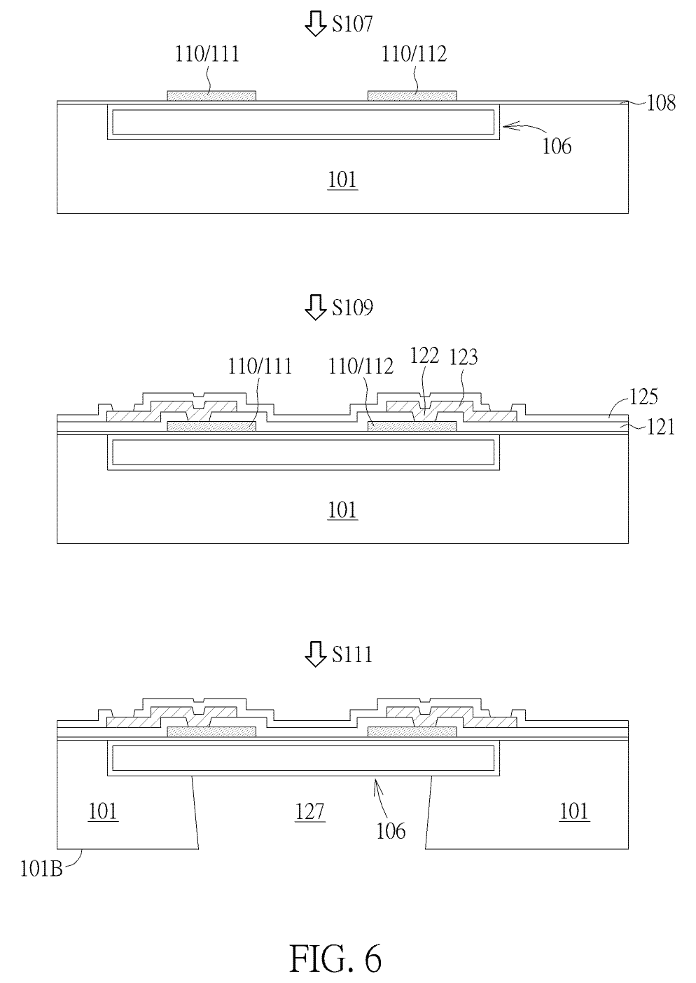

FIGS. 5 and 6 are cross-sectional views of some stages of a method for fabricating a pressure sensor structure 100 according to an embodiment of the present disclosure. Referring to FIG. 5, in step S101, firstly, a semiconductor substrate 101, such as a p-type or n-type doped silicon substrate, is provided. The semiconductor substrate 101 has a first surface 101F and a second surface 101B on opposite sides. A trench 102 is formed by etching from the first surface 101F of the semiconductor substrate 101. The depth of the trench 102 is, for example, about 2 μm to 3 μm. Next, in step S103, a first insulating layer 105B such as a silicon oxide layer is deposited in the trench 102 and on the first surface 101F of the semiconductor substrate 101. The thickness of the first insulating layer 105B is, for example, about 2000 Å to about 3000 Å. Then, a semiconductor filling layer 104, such as an undoped or lightly doped polysilicon layer, is deposited on the first insulating layer 105B to fill up the trench 102. Then, in step S105, a chemical mechanical planarization (CMP) process is performed to remove the semiconductor filling layer 104 and the first insulating layer 105B outside the trench 102. Next, a second insulating layer 105T such as a silicon oxide layer is deposited on the semiconductor filling layer 104. The thickness of the second insulating layer 105T is, for example, about 2000 Å to about 3000 Å. The first insulating layer 105B and the second insulating layer 105T together constitute an insulating layer 105 to wrap around the semiconductor filling layer 104. A composite diaphragm 106 embedded in the semiconductor substrate 101 is constructed of the semiconductor filling layer 104 and the insulating layer 105. The top surface of the composite diaphragm 106 and the first surface 101F of the semiconductor substrate 101 are on the same plane. According to the embodiments of the present disclosure, the thickness of the composite diaphragm 106 is accurately controlled by the depth of the trench 102.

Next, referring to FIG. 6, in step S107, a dielectric layer 108 such as a silicon oxide layer is deposited on the composite diaphragm 106 and the semiconductor substrate 101. A semiconductor material layer such as a polysilicon layer is deposited on the composite diaphragm 106. Then, the semiconductor material layer is patterned by photolithography and etching processes to form a plurality of resistors of a semiconductor resistor 110 with a polysilicon pattern. Next, p-type or n-type ion implantation is performed on the polysilicon pattern of these resistors according to the layout requirements of the semiconductor resistor 110. In one embodiment, referring to FIG. 2, the first resistor 111 and the second resistor 112 both with heavily doped n-type are formed simultaneously. Also, the third resistor 113 and the fourth resistor 114 both with heavily doped p-type are formed simultaneously. In some other embodiments, referring to FIG. 3, the first resistor 111, the second resistor 112, the third resistor 113, and the fourth resistor 114 all with heavily doped p-type or heavily doped n-type are formed simultaneously.

Still referring to FIG. 6, in step S109, a dielectric layer 121, a wire layer 123, and a passivation layer 125 are formed on the semiconductor resistor 110 in sequence. The conductive material of the wire layer 123 may be used to form the conductive vias 122 in the dielectric layer 121. The wire layer 123 is electrically connected to each resistor of the semiconductor resistor 110 through the conductive vias 122. Then, in step S111, a cavity 127 is formed by etching from the second surface 101B of the semiconductor substrate 101, and the semiconductor resistor 110 is located directly above the cavity 127. According to the embodiments of the present disclosure, the composite diaphragm 106 is constructed of the insulating layer 105 wrapping around the semiconductor filling layer 104. Therefore, the etching for the cavity 127 formation stops at the insulating layer 105 of the composite diaphragm 106. Furthermore, in the vertical projection direction, the boundary of the cavity 127 is within the boundary of the composite diaphragm 106. Afterwards, referring to FIG. 1, a cap plate 130, such as a glass or silicon substrate, is provided and bonded to the second surface 101B of the semiconductor substrate 101 via a bonding layer 129 to seal the cavity 127, thereby completing the pressure sensor structure 100 shown in FIG. 1.

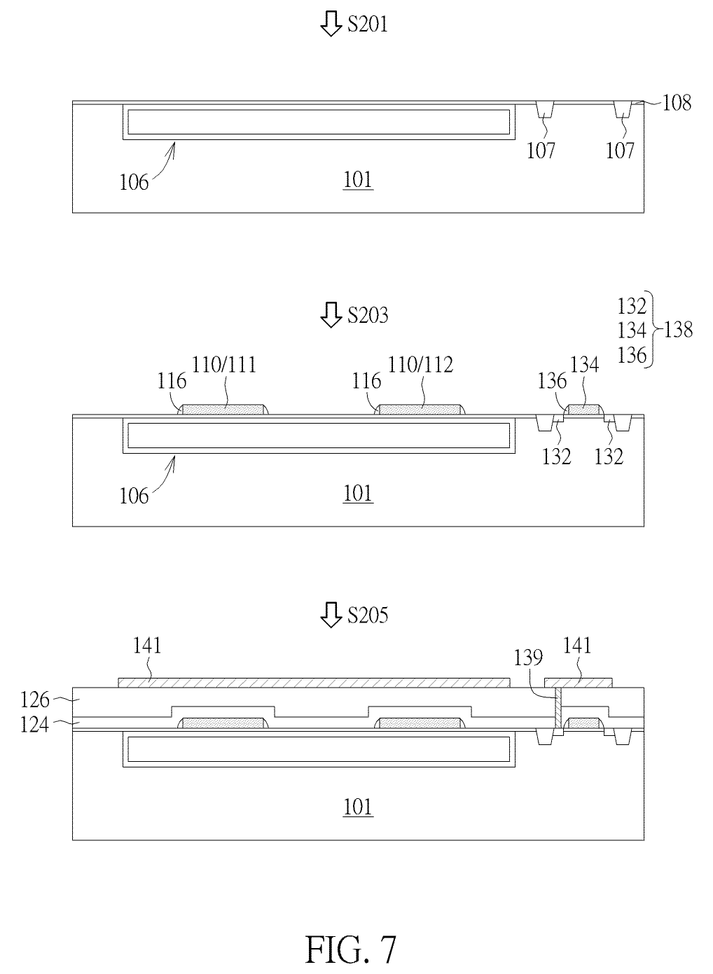

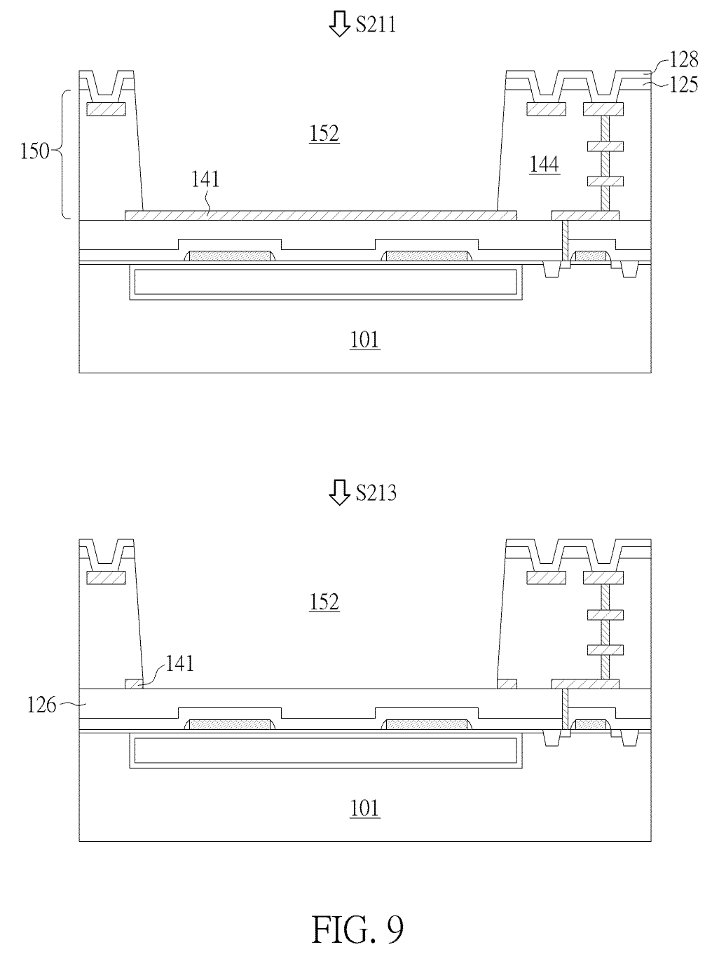

FIGS. 7, 8, 9, and 10 are cross-sectional views of some stages of a method for fabricating a pressure sensor structure 100 according to another embodiment of the present disclosure. Referring to FIG. 7, in step S201, following the aforementioned step S105 of FIG. 5, after the composite diaphragm 106 is formed, shallow trench isolation (STI) regions 107 are formed in the semiconductor substrate 101. Then, a dielectric layer 108 is formed on the composite diaphragm 106 and the semiconductor substrate 101. A portion of the dielectric layer 108 located between the STI regions 107 serves as a gate dielectric layer of the transistor 138. Next, in step S203, source and drain regions 132 are formed in the semiconductor substrate 101. In this embodiment, the semiconductor substrate 101 is a p-type silicon substrate. A gate electrode 134 of the transistor 138, and a first resistor 111, a second resistor 112, a third resistor 113, and a fourth resistor 114 of a semiconductor resistor 110 are simultaneously formed by the same deposition and etching processes. Next, spacers 136 on the sidewalls of the gate electrode 134 and spacers 116 on the sidewalls of each resistor are simultaneously formed by deposition and etching processes. Then, the source and drain regions 132 such as n-type heavily doped regions are formed. Next, in step S205, a dielectric layer 124 and an ILD layer 126 are deposited in sequence on the semiconductor resistor 110 and the transistor 138. Next, an oxide CMP process is performed to planarize the surface of the ILD layer 126 and a conductive via 139 is formed in the dielectric layer 124 and the ILD 126 to be electrically connected to the source or drain region 132. Thereafter, a first metal layer 141 is formed on the ILD layer 126 by deposition and etching processes, and a portion of the first metal layer 141 is electrically connected to the transistor 138 and the semiconductor resistor 110 by the conductive via 139. Also, a portion of the first metal layer 141 above the composite diaphragm 106 may be used as an etch stop layer of the pressure sensor window 152 in FIG. 9.

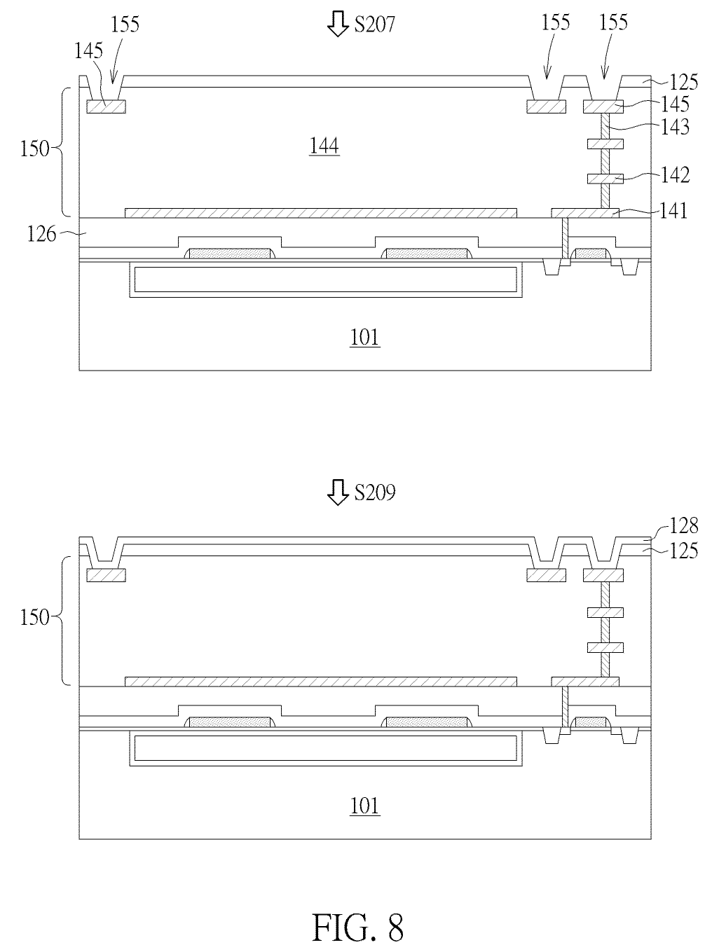

Referring to FIG. 8, in step S207, multiple intermediate metal layers 142, multiple conductive vias 143, a top metal layer 145, and multiple IMD layers 144 are formed on the first metal layer 141 to construct an interconnection layer 150. Then, a passivation layer 125 is formed on the interconnection layer 150, and a plurality of openings 155 is formed to expose the top metal layer 145. Next, in step S209, a cap layer 128 is deposited on the passivation layer 125, covering the passivation layer 125 and the exposed top metal layer 145. In one embodiment, the cap layer 128 is, for example, a silicon oxide layer, and the passivation layer 125 is, for example, a silicon nitride layer.

Referring to FIG. 9, in step S211, a pressure sensor window 152 is formed by etching to penetrate the cap layer 128, the passivation layer 125, and the interconnection layer 150. The etching of the pressure sensor window 152 firstly stops at the first metal layer 141. Then, in step S213, the first metal layer 141 is etched and the etching stops at the ILD layer 126. The pressure sensor window 152 is located directly above the semiconductor resistor 110. During the etching processes of step S211 and step S213, the cap layer 128 protects the exposed top metal layer 145.

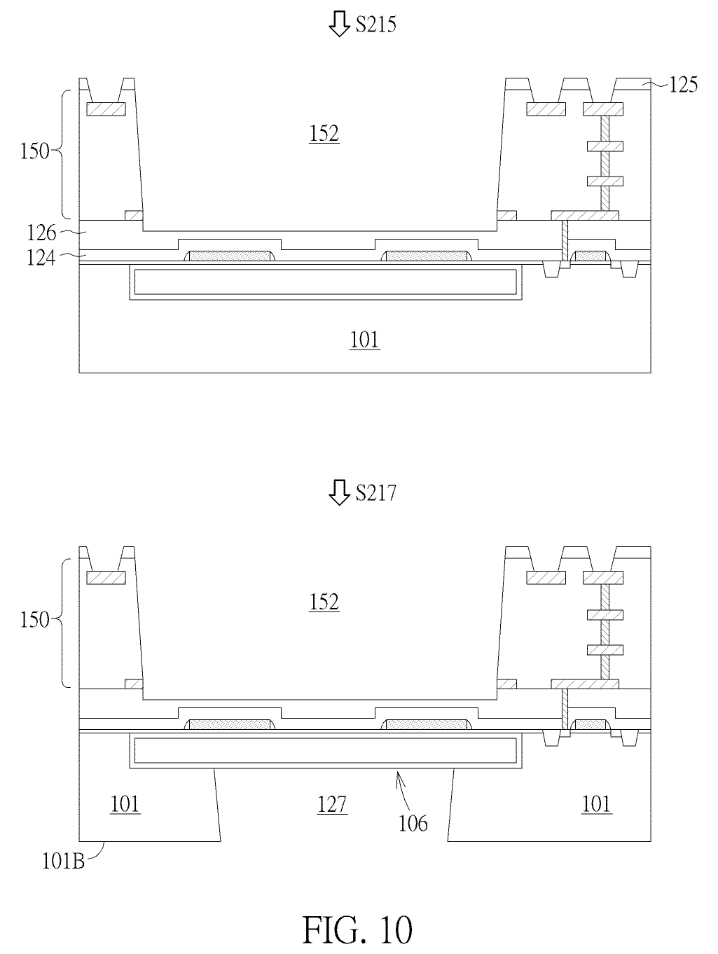

Referring to FIG. 10, in step S215, the cap layer 128 is etched to expose the top metal layer 145 and a portion of the ILD layer 126 is also removed by the same etch. Thereafter, the bottom of the pressure sensor window 152 is closer to the semiconductor resistor 110. Next, in step S217, after the pressure sensor window 152 is formed, a cavity 127 is formed by etching from the second surface 101B of the semiconductor substrate 101. The etching of the cavity 127 formation stops at the insulating layer of the composite diaphragm 106. The semiconductor resistor 110 is located directly above the cavity 127. Furthermore, in the vertical projection direction, the boundary of the pressure sensor window 152 may exceed the boundary of the cavity 127, and the boundary of the cavity 127 is within the boundary of the composite diaphragm 106. Afterwards, referring to FIG. 4, a cap plate 130 is provided and bonded to the second surface 101B of the semiconductor substrate 101 via the bonding layer 129 to seal the cavity 127, thereby completing the pressure sensor structure 100 of FIG. 4.

According to some embodiments of the present disclosure, the pressure sensor structures include a composite diaphragm embedded in a semiconductor substrate and located near the front side of the semiconductor substrate. The composite diaphragm is formed by filling a trench in the semiconductor substrate, thereby accurately controlling the composite diaphragm’s thickness to improve the sensitivity of the pressure sensor structures. Furthermore, the composite diaphragm is constructed by wrapping a semiconductor filling layer with an insulating layer. A cavity is formed by etching from the back side of the semiconductor substrate. The insulating layer of the composite diaphragm serves as an etch stop layer, thereby facilitating control of the etching of cavity formation. Moreover, the filling layer of the composite diaphragm may be made of semiconductor material, thereby facilitating integration with CMOS transistors and exhibiting good deformation characteristics.

In addition, the pressure sensor structures of the present disclosure include the composite diaphragm. Therefore, the pressure sensor structures do not require a semiconductor-on-insulator (SOI) substrate, thereby saving manufacturing costs. Moreover, the pressure sensor structures of the present disclosure may use a p-type semiconductor substrate to facilitate integration with CMOS transistors.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pressure sensor structure, comprising:
a semiconductor substrate, having a first surface and a second surface on opposite sides;
a composite diaphragm, embedded in the semiconductor substrate and located near the first surface;
a cavity, disposed in the semiconductor substrate and extending from the second surface to the composite diaphragm;
a semiconductor resistor, disposed on the composite diaphragm and located directly above the cavity; and
a cap plate, bonded to the semiconductor substrate to seal the cavity.

2. The pressure sensor structure of claim 1, wherein the composite diaphragm comprises a semiconductor filling layer and an insulating layer wrapping around the semiconductor filling layer, and a top surface of the composite diaphragm and the first surface of the semiconductor substrate are on the same plane.

3. The pressure sensor structure of claim 2, wherein a composition of the semiconductor filling layer comprises an undoped polysilicon or a lightly doped polysilicon, and a composition of the insulating layer comprises silicon oxide.

4. The pressure sensor structure of claim 1, wherein in a vertical projection direction, a boundary of the cavity is within a boundary of the composite diaphragm.

5. The pressure sensor structure of claim 1, further comprising:
an interconnect layer, disposed above the semiconductor substrate;
a pressure sensor window, penetrating the interconnect layer and located directly above the semiconductor resistor; and
a transistor, disposed in the semiconductor substrate.

6. The pressure sensor structure of claim 5, wherein the interconnect layer is electrically connected to the transistor and the semiconductor resistor.

7. The pressure sensor structure of claim 5, wherein the transistor comprises a gate structure, and a composition of the semiconductor resistor is the same as a composition of the gate structure.

8. The pressure sensor structure of claim 1, wherein a composition of the semiconductor resistor comprises a doped polysilicon, and the semiconductor resistor is configured as a Wheatstone bridge circuit.

9. The pressure sensor structure of claim 1, wherein the semiconductor resistor comprises:
a first resistor and a second resistor, both having a first conductivity type and separately disposed along a first direction; and
a third resistor and a fourth resistor, both having a second conductivity type and separately disposed along a second direction,
wherein the second direction is different from the first direction, long axes of both the first resistor and the second resistor are in the first direction, and long axes of both the third resistor and the fourth resistor are in the second direction.

10. The pressure sensor structure of claim 1, wherein the semiconductor resistor comprises:
a first resistor and a second resistor, separately disposed along a first direction; and
a third resistor and a fourth resistor, separately disposed along a second direction,
wherein the second direction is different from the first direction, long axes of all the first resistor, the second resistor, the third resistor, and the fourth resistor are in the second direction, and the first resistor, the second resistor, the third resistor, and the fourth resistor all have the same conductivity type.

11. A method of fabricating a pressure sensor structure, comprising:
providing a semiconductor substrate having a first surface and a second surface on opposite sides;
forming a trench by etching from the first surface of the semiconductor substrate;
forming a composite diaphragm in the trench;
forming a semiconductor resistor on the composite diaphragm;
forming a cavity by etching from the second surface of the semiconductor substrate, wherein etching of the cavity formation stops at the composite diaphragm, and the semiconductor resistor is located directly above the cavity; and
providing a cap plate to be bonded to the semiconductor substrate to seal the cavity.

12. The method of claim 11, wherein forming the composite diaphragm comprises:
forming a semiconductor filling layer to fill the trench; and
forming an insulating layer to wrap around the semiconductor filling layer,
wherein a top surface of the composite diaphragm and the first surface of the semiconductor substrate are on the same plane.

13. The method of claim 11, further comprising forming a transistor in the semiconductor substrate, wherein the semiconductor substrate comprises a p-type silicon substrate.

14. The method of claim 13, wherein the semiconductor resistor and a gate structure of the transistor are formed simultaneously by the same process step.

15. The method of claim 13, further comprising:
forming an interconnect layer over the semiconductor substrate; and
forming a pressure sensor window to penetrate the interconnection layer, wherein the pressure sensor window is located directly above the semiconductor resistor.

16. The method of claim 15, wherein forming the cavity after the pressure sensor window is formed.

17. The method of claim 15, wherein in a vertical projection direction, a boundary of the pressure sensor window exceeds a boundary of the cavity.

18. The method of claim 11, wherein in a vertical projection direction, a boundary of the cavity is within a boundary of the composite diaphragm.

19. The method of claim 11, wherein forming the semiconductor resistor comprises:
simultaneously forming a first resistor and a second resistor, both having a first conductivity type, and separated along a first direction, wherein long axes of both the first resistor and the second resistor are in the first direction; and
simultaneously forming a third resistor and a fourth resistor, both having a second conductivity type, and separated along a second direction, wherein long axes of both the third resistor and the fourth resistor are in the second direction.

20. The method of claim 11, wherein forming the semiconductor resistor comprises:
simultaneously forming a first resistor, a second resistor, a third resistor, and a fourth resistor, all having the same conductivity type,
wherein the first resistor and the second resistor are separated along a first direction, the third resistor and the fourth resistor are separated along a second direction, and long axes of all the first resistor, the second resistor, the third resistor, and the fourth resistor are in the second direction.
